(19) United States
(12) Patent Application Publication
(10) Pub. No.: US 2021/0344925 A1
(43) Pub. Date: Nov. 4, 2021

(54) BLOCK SIZE BASED MOTION VECTOR CODING IN AFFINE MODE

(71) Applicant: InterDigital VC Holdings, Inc., Wilmington, DE (US)

(72) Inventors: Franck Galpin, Thorigne-Fouillard (FR); Fabrice Le Leannec, Mouaze (FR); Edouard Francois, Bourg des Comptes (FR)

(21) Appl. No.: 17/281,137

(22) PCT Filed: Oct. 1, 2019
(86) PCT No.: PCT/US2019/053927

§ 371 Date: Mar. 29, 2021

(30) Foreign Application Priority Data
Oct. 4, 2018 (EP) 18306311.4

(51) Int. Cl. H04N 19/137; H04N 19/124; H04N 19/119; H04N 19/176

(52) U.S. Cl. CPC H04N 19/137; H04N 19/176; H04N 19/119; H04N 19/124

(57) ABSTRACT

At least a method and an apparatus are presented for efficiently encoding or decoding video. For example, a plurality of motion vectors are obtained for used in determining motion information for a block using affine modeling, wherein at least one of the plurality of motion vectors is determined based on a block size of the block. The video is then encoded or decoded based on the plurality of motion vectors.

### TECHNICAL FIELD

At least one of the present embodiments generally relates to a method or an apparatus for video encoding or decoding, and more particularly, to a method or an apparatus for efficiently providing video compression and/or decompression based on coding of one or more motion vectors that takes into account a block size, especially for affine mode motion coding.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

Recent additions to video compression technology include various industry standards, versions of the reference software and/or documentations such as Joint Exploration Model (JEM) and later VTM (Versatile Video Coding (WC) Test Model) being developed by the JVET (Joint Video Exploration Team) group. The aim is to make further improvements to the existing HEVC (High Efficiency Video Coding) standard.

A recent addition to high compression technology includes using a motion model based on affine modeling. In particular, affine modeling is used for motion compensation for encoding and decoding of video pictures. In general, affine modeling is a model using at least two parameters such as, e.g., two control point motion vectors (CPMVs) representing the motion at the respective corners of a block of picture, that allows deriving a motion field for the whole block of a picture to simulate, e.g., rotation and homothety (zoom).

### SUMMARY

The drawbacks and disadvantages of the prior art are solved and addressed by the general aspects described herein.

According to a first aspect, there is provided a method. The method comprises: obtaining a plurality of motion vectors for used in determining motion information for a block using affine modeling, wherein at least one of the plurality of motion vectors is determined based on a block size of the block; and encoding the video based on the plurality of motion vectors.

According to another aspect, there is provided a second method. The method comprises: obtaining a plurality of motion vectors for used in determining motion information for a block using affine modeling, wherein at least one of the plurality of motion vectors is determined based on a block size of the block; and decoding the video based on the plurality of motion vectors.

According to another aspect, there is provided an apparatus. The apparatus comprises one or more processors, wherein the one or more processors are configured to: obtain a plurality of motion vectors for used in determining motion information for a block using affine modeling, wherein at least one of the plurality of motion vectors is determined based on a block size of the block; and encode the video based on the plurality of motion vectors.

According to another aspect, there is provided another apparatus. The apparatus comprises one or more processors, wherein the one or more processors are configured to: obtain a plurality of motion vectors for used in determining motion information for a block using affine modeling, wherein at least one of the plurality of motion vectors is determined based on a block size of the block; and decode the video based on the plurality of motion vectors.

According to another general aspect of at least one embodiment, wherein the block size of the block is a width of the block.

According to another general aspect of at least one embodiment, wherein the at least one of the plurality of motion vectors is determined for its pixel accuracy.

According to another general aspect of at least one embodiment, wherein the pixel accuracy decreases with increasing block size larger than a threshold size.

According to another general aspect of at least one embodiment, wherein at least another one of the plurality of motion vectors is determined based on a height of the block.

According to another general aspect of at least one embodiment, wherein at least another additional one of the plurality of motion vectors is determined independent of the block size.

According to another general aspect of at least one embodiment, wherein the plurality of motion vectors are control point motion vectors for the affine modeling.

According to another general aspect of at least one embodiment, wherein the plurality of motion vectors are expressed as a motion vector difference.

According to another general aspect of at least one embodiment, wherein the affine modeling is in affine advanced motion vector prediction (AMVP) mode.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates a block diagram of an embodiment of a video encoder.

FIG. 2 illustrates a block diagram of an embodiment of a video decoder.

FIG. 3 shows a pictorial example illustrating Coding Tree Unit and Coding Tree concepts to represent a compressed HEVC picture.

FIG. 4 shows a pictorial example illustrating a division of a Coding Tree Unit into Coding Units, Prediction Units and Transform Units.

FIG. 5 shows an example of simple affine model used in the Joint Exploration

Model.

FIG. 6 shows an example of a 4×4 sub-CU based affine motion vector field.

FIG. 7 shows an example of a motion vector prediction process for Affine Inter CUs.

FIG. 8 shows an example of a process for creating new candidates in affine affine advanced motion vector prediction AMVP process.

FIG. 9 shows an example of motion vector prediction candidates in the Affine Merge mode.

FIG. 10 shows an example of spatial derivation of affine motion field control points in the case of Affine Merge.

FIG. 11 shows a block diagram of a system in which aspects of the present embodiments may be implemented.

### DETAILED DESCRIPTION

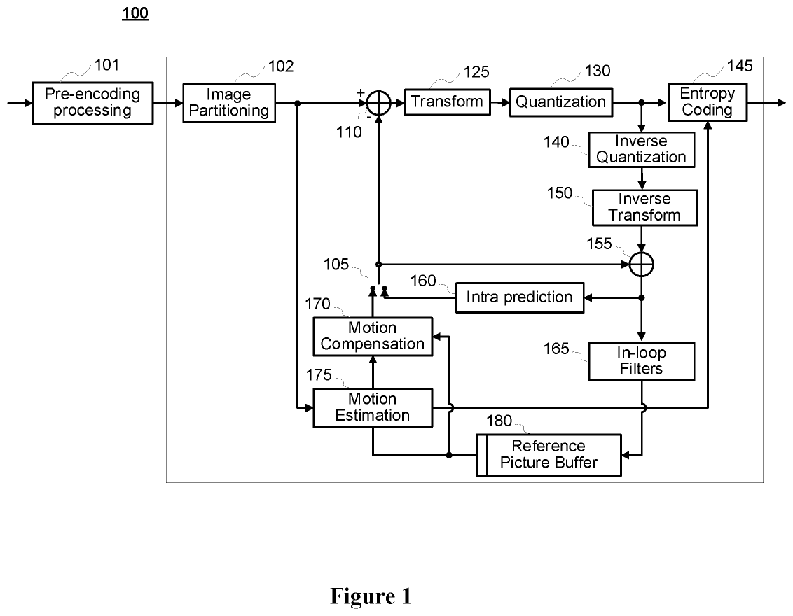

FIG. 1 illustrates an example video encoder 100, such as a High Efficiency Video Coding (HEVC) encoder. FIG. 1 may also illustrate an encoder in which improvements are made to the HEVC standard or an encoder employing technologies similar to HEVC, such as a WC (Versatile Video Coding) encoder under development by JVET (Joint Video Exploration Team).

In the present application, the terms “reconstructed” and “decoded” may be used interchangeably, the terms “encoded” or “coded” may be used interchangeably, and the terms “image”, “picture” and “frame” may be used interchangeably. Usually, but not necessarily, the term “reconstructed” is used at the encoder side while “decoded” is used at the decoder side.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In HEVC, to encode a video sequence with one or more pictures, a picture is partitioned (102) into one or more slices where each slice may include one or more slice segments. A slice segment is organized into coding units, prediction units, and transform units. The HEVC specification distinguishes between “blocks” and “units,” where a “block” addresses a specific area in a sample array (e.g., luma, Y), and the “unit” includes the collocated blocks of all encoded color components (e.g., Y, Cb, Cr, or monochrome), syntax elements, and prediction data that are associated with the blocks (e.g., motion vectors).

For coding, a picture is partitioned into coding tree blocks (CTB) of square shape with a configurable size, and a consecutive set of coding tree blocks is grouped into a slice. A Coding Tree Unit (CTU) contains the CTBs of the encoded color components. A CTB is the root of a quadtree partitioning into Coding Blocks (CB), and a Coding Block may be partitioned into one or more Prediction Blocks (PB) and forms the root of a quadtree partitioning into Transform Blocks (TBs). Corresponding to the Coding Block, Prediction Block, and Transform Block, a Coding Unit (CU) includes the Prediction Units (PUs) and the tree-structured set of Transform Units (TUs), a PU includes the prediction information for all color components, and a TU includes residual coding syntax structure for each color component. The size of a CB, PB, and TB of the luma component applies to the corresponding CU, PU, and TU. In the present application, the term “block” may be used to refer, for example, to any of CTU, CU, PU, TU, CB, PB, and TB. In addition, the “block” may also be used to refer to a macroblock and a partition as specified in H.264/AVC or other video coding standards, and more generally to refer to an array of data of various sizes.

In the exemplary encoder 100, a picture is encoded by the encoder elements as described below. The picture to be encoded is processed in units of CUs. Each CU is encoded using either an intra or inter mode. When a CU is encoded in an intra mode, it performs intra prediction (160). In an inter mode, motion estimation (175) and compensation (170) are performed. The encoder decides (105) which one of the intra mode or inter mode to use for encoding the CU, and indicates the intra/inter decision by a prediction mode flag. Prediction residuals are calculated by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder may also skip the transform and apply quantization directly to the non-transformed residual signal on a 4×4 TU basis. The encoder may also bypass both transform and quantization, i.e., the residual is coded directly without the application of the transform or quantization process. In direct PCM coding, no prediction is applied and the coding unit samples are directly coded into the bitstream.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture, for example, to perform deblocking/SAO (Sample Adaptive Offset) filtering to reduce encoding artifacts. The filtered image is stored at a reference picture buffer (180).

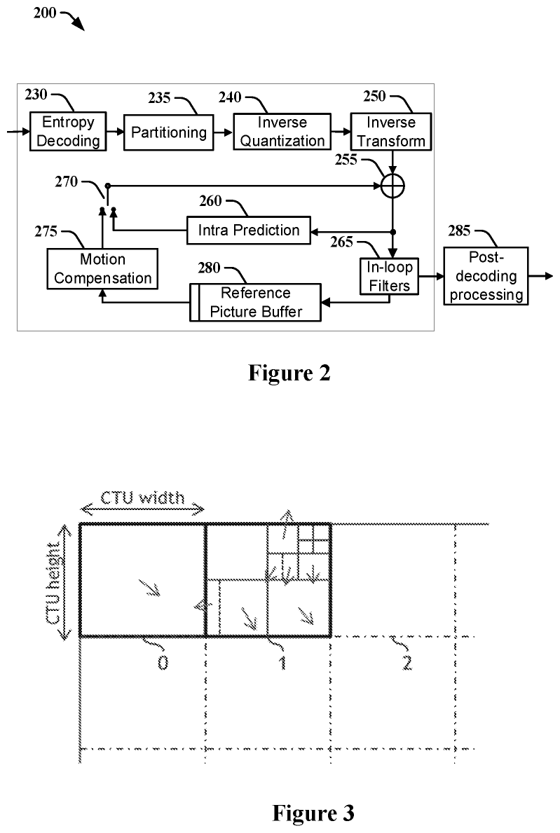

FIG. 2 illustrates a block diagram of an example video decoder 200, such as an HEVC decoder. In decoder 200, a bitstream is decoded by the decoder elements as described below. Video decoder 200 generally performs a decoding pass reciprocal to the encoding pass as described in FIG. 1, which performs video decoding as part of encoding video data. FIG. 2 may also illustrate a decoder in which improvements are made to the HEVC standard or a decoder employing technologies similar to HEVC, such as a VVC decoder.

In particular, the input of the decoder includes a video bitstream, which may be generated by video encoder 100. The bitstream is first entropy decoded (230) to obtain transform coefficients, motion vectors, picture partitioning information, and other coded information. The picture partitioning information indicates the size of the CTUs, and a manner a CTU is split into CUs, and possibly into PUs when applicable. The decoder may therefore divide (235) the picture into CTUs, and each CTU into CUs, according to the decoded picture partitioning information. The transform coefficients are de-quantized (240) and inverse transformed (250) to decode the prediction residuals.

Combining (255) the decoded prediction residuals and the predicted block, an image block is reconstructed. The predicted block may be obtained (270) from intra prediction (260) or motion-compensated prediction (i.e., inter prediction) (275). In case of bi-prediction, two motion compensated predictions may be combined with a weighted sum. In-loop filters (265) are applied to the reconstructed image. The filtered image is stored at a reference picture buffer (280).

The decoded picture can further go through post-decoding processing (285), for example, an inverse color transform (e.g., conversion from YCbCr 4:2:0 to RGB 4:4:4) or an inverse remapping performing the inverse of the remapping process performed in the pre-encoding processing (101). The post-decoding processing may use metadata derived in the pre-encoding processing and signaled in the bitstream.

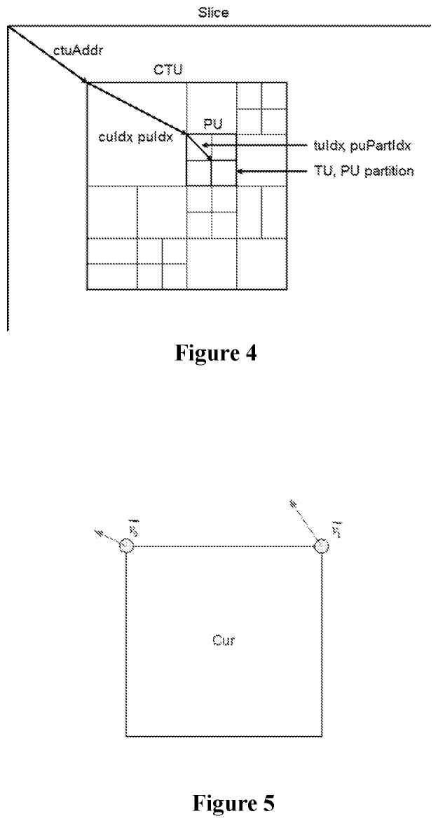

In the HEVC video compression standard, a picture is divided into so-called Coding Tree Units (CTU), whose size is typically 64×64, 128×128, or 256×256 pixels. Each CTU is represented by a Coding Tree in the compressed domain. This is a quad-tree division of the CTU, where each leaf is called a Coding Unit (CU), as illustrated in FIG. 3. Each CU is then given some intra or inter prediction parameters (e.g., Prediction Info). To do so, it is spatially partitioned into one or more Prediction Units (PUs), each PU being assigned some prediction information. The intra or inter coding mode is assigned on the CU level, as illustrated in FIG. 4.

Some richer motion models are supported to improve temporal prediction. To do so, a PU can be spatially divided into sub-PU and a richer model can be used to assign each sub-PU a dedicated motion vector. A CU is no more divided into PU or TU, and some motion data is directly assigned to each CU. In this new codec design, a CU can be divided into sub-CU and a motion vector can be computed for each sub-CU. One of the new motion models is the affine model, which basically consists in using an affine model to represent the motion vectors in a CU.

The motion model used is illustrated by FIG. 5. The affine motion field consists in the following motion vector component values for each position (x,y) inside the considered block:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \\ affine model used to generate the \\ motion field inside a CU for prediction \qquad Equation 1$$

where (v₀ₓ, v_{0y}) and (v₁ₓ, v_{1y}) are the so-called control point motion vectors used to generate the affine motion field. (v₀ₓ, v_{0y}) is the motion vector top-left corner control point. (v₁ₓ, v_{1y}) is the motion vector top-right corner control point.

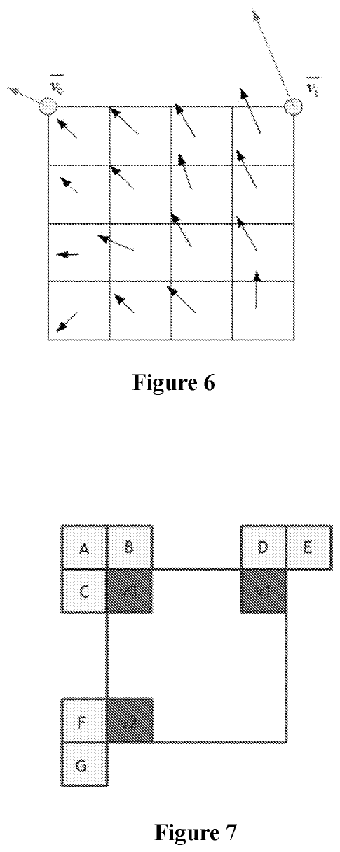

In practice, to keep complexity reasonable, a motion vector is computed for each 4×4 sub-block (sub-CU) of the considered CU, as illustrated in FIG. 6. An affine motion vector is computed from the control point motion vectors, at the position of the center of each sub-block. The obtained motion vector (MV) is represented at 1/16 pel accuracy.

As a result, the temporal of a coding unit in the affine mode consists in motion compensated predicting each sub-block with its own motion vector. Note that a model with 3 control points is also possible. Affine motion compensation can be used in 3 ways: Affine Inter (AF_INTER), Affine Merge and Affine Template. Affine Inter and Merge modes are introduced hereafter.

### Affine Inter (AF_INTER)

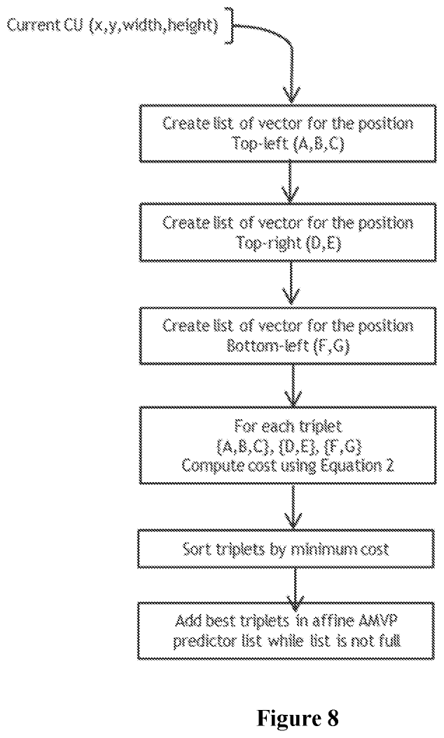

FIG. 8 illustrates an exemplary process for creating new candidates in affine advanced motion vector prediction (AMVP) mode. A CU in AMVP mode, whose size is larger than 8×8, can be predicted in Affine Inter mode. This is signaled through a flag in the bit-stream. The generation of the Affine Motion Field for that inter CU includes determining control point motion vectors (CPMV), which are obtained by the decoder through the addition of a motion vector difference and a control point motion vector prediction (CPMVP). The CPMVP is a pair of motion vector candidates, respectively taken from the list (A, B, C) and (D, E) illustrated in FIG. 7. Up to 6 CPMVP may be obtained (3 for \vec{v₀} multiply by 2 for \vec{v₁}).

First CPMVP are checked for validity using Equation 2, for a block of height H and Width W:

$$\vec{Δ H o r} = \vec{v 1} - \vec{v 0} \\ DiffH = \frac{W}{2} \\ DiffV = \frac{H}{2} \\ validity = \vec{Δ H o r} ! = \vec{0} \&\& abs ( \vec{Δ H o r} \cdot X ) \leq DiffH \&\& abs ( \vec{Δ H o r} \cdot Y ) \leq DiffV \&\& abs ( \vec{Δ V e r} \cdot X ) \leq DiffH \&\& abs ( \vec{Δ V e r} \cdot Y ) \leq DiffV ) \\ Validity test for each CPMVP \qquad Equation 2$$

Valid CPMVP are then sorted depending on the value of a third motion vector \vec{v₂}, (taken from position F or G of FIG. 7). The closest \vec{v₂} is to the vector given by the affine motion model for the 4×4 sub-block at the same position as \vec{v₂}, the better is the CPMVP.

For a block of Height H and Width W, the cost of each CPMVP is computed with Equation 3. In the following equation X and Y are respectively the horizontal and vertical components of a motion vector:

\vec{ΔHor}=\vec{v1}−\vec{v0}

\vec{ΔVer}=\vec{v2}−\vec{v0}

cost=abs(\vec{ΔHor}·X*H−\vec{ΔVer}·Y*W)+abs(\vec{ΔHor}·Y*H+\vec{ΔVer}·X*W)

### Equation 3: Cost Computed for Each CPMVP

### Affine Merge Mode

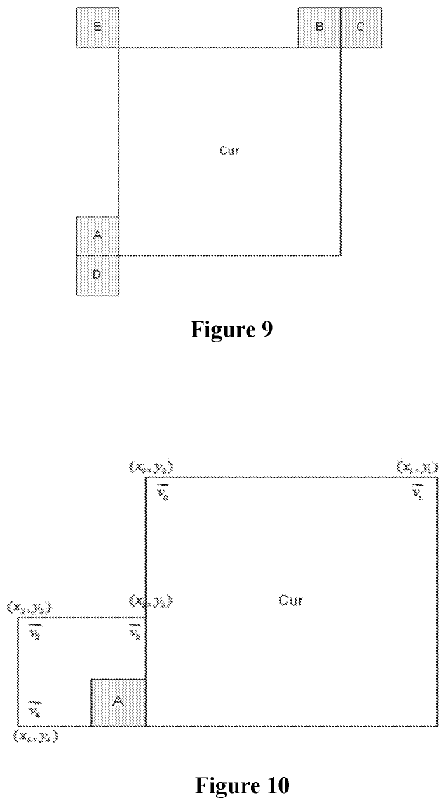

In Affine Merge mode, a CU-level flag indicates if a merge CU employs affine motion compensation. If so, then the first available neighboring CU that has been coded in an affine mode is selected, among the ordered set of candidate positions (A, B, C, D, E) of FIG. 9.

Once the first neighboring CU in affine mode is obtained, then the 3 motion vectors \vec{v₂}, \vec{v₃}, and \vec{v₄} from the top-left, top-right and bottom-left corners of the neighboring CU are retrieved (see FIG. 10).

Based on these three vectors, the two CPMV of the top-left and top-right corners of current CU are derived as follows:

$$\vec{{v}_{0}} = \vec{{v}_{2}} + ( \vec{{v}_{4}} - \vec{{v}_{2}} ) ( \frac{\begin{matrix}{Y}_{curr} - \\ {Y}_{n e i g h b}\end{matrix}}{{H}_{n e i g h b}} ) + ( \vec{{v}_{3}} - \vec{{v}_{2}} ) ( \frac{\begin{matrix}{X}_{curr} - \\ {X}_{n e i g h b}\end{matrix}}{{W}_{n e i g h b}} ) \\ \vec{{v}_{1}} = \vec{{v}_{0}} + ( \vec{{v}_{3}} - \vec{{v}_{2}} ) ( \frac{{W}_{curr}}{{W}_{n e i g h b}} ) \\ derivation of current CU ’ s CPMV based on the three corner motion vectors of the \\ neighboring CU \qquad Equation 4$$

When the control point motion vectors \vec{v₀} and \vec{v₁} of current CU are obtained, the motion field inside current CU is computed on a 4×4 sub-CU basis, through the model of Equation 1.

### Coding of the Corners

The affine model is expressed using 2 (or 3) corners of the block. In AMVP mode, the vectors are coded using a predictor mvp and a residual vector mvd: mv=mvp+mvd. For the first corner, Top-left (TL), the mvd is coded as mvd_TL=mv_TL−mvp_TL. For the second corner, Top-right (TR), the mvd is coded as for the top-left: mvd_TR=mv_TR−mvp_TR.

Alternatively, the mvd is coded differentially to the mvd_TL: mvd_TR=mv_TR−mvp_TR−mvd_TL. The coding of the third corner uses the same principle. However, with such coding, the mvd use the same accuracy for all corners and all block size, but the needed accuracy for the second (resp. third) mvd may depend on the block width (resp. height).

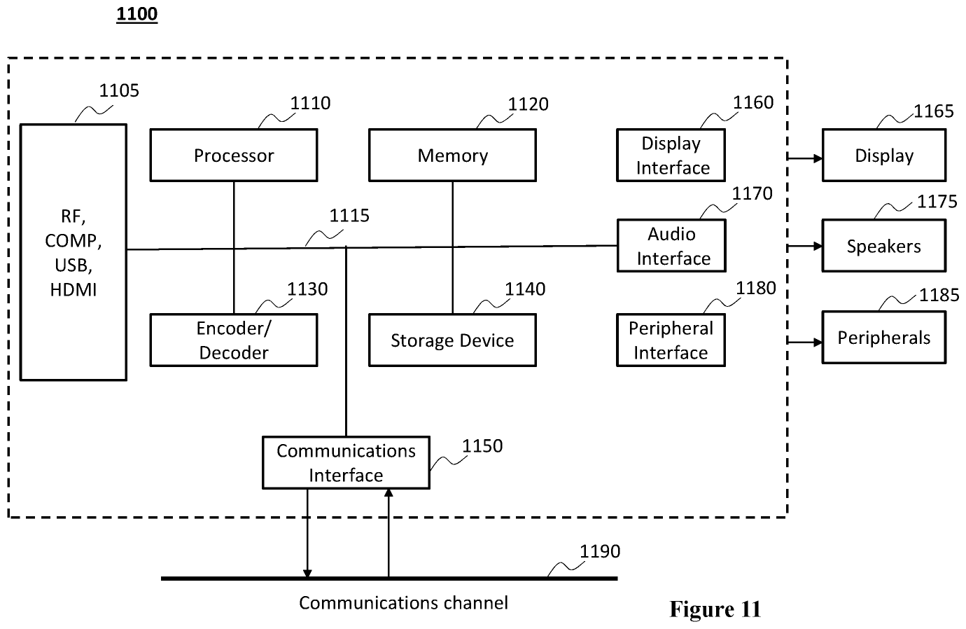

In various embodiments, the encoder 100 of FIG. 1, decoder 200 of FIG. 2 and system 1100 of FIG. 11 (to be described later) are adapted to implement one or more aspects of the present embodiments described herein.

In at least one embodiment, the coding of the mvd in AMVP affine mode takes into account the block size, without any additional signaling. In such embodiment, the mvd accuracy for AMVP affine mode is set as follows:
The mvd accuracy of the first corner top-left (TL) uses the nominal accuracy. Alternatively, the accuracy of the first corner mvd uses an adaptive motion vector range (AMVR) accuracy signaled in the bitstream.
The mvd of the second corner (Top-right), uses an accuracy depending on the block width.
The mvd of the third corner (bottom-left), uses an accuracy depending on the block height.

The case of the second corner is described hereafter but the same principle applies for the third one.

### First Embodiment

We denote by L the block width, A the nominal accuracy (for example A=⅛th or A=¼ pixels), mvd=mv-mvp the motion vector difference to encode, expressed as an integer with the nominal accuracy and B a threshold on the desired accuracy.

In a first embodiment, the mvd for encoding is given by:

mvd_e=(B*mvd/L), where / is the integer division, if L>B

mvd_e=mvd otherwise

On decoder side, the mvd is decoded using:

mvd=L*mvd_e/B+(L/(2*B)) if L>B

mvd=mvd_e otherwise.

According to a variant embodiment, the above mvd quantization process takes the following form:

mvd_e=(B*mvd+(L/2))/L

The advantage of this variant is a lower distance between the original, non-quantized, mvd value and the de-quantized mvd obtained when reconstructing the considered motion vector difference mvd on the decoder side.

According to a variant embodiment, the quantization of the mvd can be done using only power of 2 quantizer. This allows decrease in complexity. Typically, a fixed value is set for B (e.g. B=16), meaning that the accuracy will be the same as the one of the first mvd for block smaller than 16 pixels in width. In this case the quantizer can be given by a table. For example, for B=16, we have the following table for the mvd quantization:

| Block width | Mvd quantizer = q |
|---|---|
| 4 | 1 |
| 8 | 1 |
| 16 | 1 |
| 24 | 1 |
| 32 | 2 |
| 48 | 2 |
| 64 | 3 |
| 128 | 4 |

In this case the quantization of the vector mvd to encode is then given by:

mvd_e=(mvd)/(2\hat{ }(q−1))

Accordingly, the above embodiment illustrates that the motion accuracy (e.g., in pixel resolution) is decreased with increasing block size after a certain block size threshold, due to the increasing value of the quantizer q used to quantize the Mvd.

### Second Embodiment

According to a second embodiment for the mvd coding process, the mvd_e vector to encode is the difference between the motion vector difference of the second corner control point motion vector and motion vector difference of the first corner control point motion vector.

Therefore, mvd_e is expressed as follows:

mvd_e=(B*mvdd/L)

with mvdd=mvd_TR−mvd_TL=(mv_TL−mvp_TL)−(mv_TR−mvp_TR)

Scaling the second order motion vector difference is mathematically equivalent to computing the motion vector of the considered affine motion field, at the intermediate spatial position I between the top-left corner TL and the top-right corner TR of the current block, equal to:

I=TL+(B/L)*\vec{(TR−TL)}

The motion vector position of the considered affine model at that spatial position is given by:

mv_I=mv_TL+(B/L)*(mv_TR−mv_TR)

The second order motion vector position at spatial position I is strictly equal to the above motion vector to encode mvd_e=(B*mvdd/L)

### Third Embodiment

According to a third embodiment, one may want to quantize the first order motion vector difference associated to spatial position I, instead of the second order motion vector difference at that position.

In that case, the vector to encode is given by:

mvd_I=mvd_TL+(B/L)*(mvd_TR−mvd_TL)

Although former embodiments describe a block-size based residual motion vector using the AMVP coding mode, the method also applies to other coding modes for residual motion vectors.

FIG. 11 illustrates a block diagram of an example of a system 1100 in which various aspects and embodiments are implemented. System 1100 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1100, singly or in combination, can be embodied in a single integrated circuit, multiple ICs, and/or discrete components. For example, in at least one embodiment, the processing and encoder/decoder elements of system 1100 are distributed across multiple ICs and/or discrete components. In various embodiments, the system 1100 is communicatively is coupled to other similar systems, or to other electronic devices, via, for example, a communications bus or through dedicated input and/or output ports. In various embodiments, the system 1100 is configured to implement one or more of the aspects described in this document.

The system 1100 includes at least one processor 1110 configured to execute instructions loaded therein for implementing, for example, the various aspects described in this document. Processor 1110 can include embedded memory, input output interface, and various other circuitries as known in the art. The system 1100 includes at least one memory 1120 (e.g., a volatile memory device, and/or a non-volatile memory device). System 1100 includes a storage device 1140, which can include non-volatile memory and/or volatile memory, including, but not limited to, EEPROM, ROM, PROM, RAM, DRAM, SRAM, flash, magnetic disk drive, and/or optical disk drive. The storage device 1140 can include an internal storage device, an attached storage device, and/or a network accessible storage device, as non-limiting examples.

System 1100 includes an encoder/decoder module 1130 configured, for example, to process data to provide an encoded video or decoded video, and the encoder/decoder module 1130 can include its own processor and memory. The encoder/decoder module 1130 represents module(s) that can be included in a device to perform the encoding and/or decoding functions. As is known, a device can include one or both of the encoding and decoding modules. Additionally, encoder/decoder module 1130 can be implemented as a separate element of system 1100 or can be incorporated within processor 1110 as a combination of hardware and software as known to those skilled in the art.

Program code to be loaded onto processor 1110 or encoder/decoder 1130 to perform the various aspects described in this document can be stored in storage device 1140 and subsequently loaded onto memory 1120 for execution by processor 1110. In accordance with various embodiments, one or more of processor 1110, memory 1120, storage device 1140, and encoder/decoder module 1130 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In several embodiments, memory inside of the processor 1110 and/or the encoder/decoder module 1130 is used to store instructions and to provide working memory for processing that is needed during encoding or decoding. In other embodiments, however, a memory external to the processing device (for example, the processing device can be either the processor 1110 or the encoder/decoder module 1130) is used for one or more of these functions. The external memory can be the memory 1120 and/or the storage device 1140, for example, a dynamic volatile memory and/or a non-volatile flash memory. In several embodiments, an external non-volatile flash memory is used to store the operating system of a television. In at least one embodiment, a fast, external dynamic volatile memory such as a RAM is used as working memory for video coding and decoding operations, such as for MPEG-2, HEVC, or WC (Versatile Video Coding).

The input to the elements of system 1100 can be provided through various input devices as indicated in block 1105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 1105 have associated respective input processing elements as known in the art. For example, the RF portion can be associated with elements necessary for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one is or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 1100 to other electronic devices across USB and/or HDMI connections. It is to be understood that various aspects of input processing, for example, Reed-Solomon error correction, can be implemented, for example, within a separate input processing IC or within processor 1110 as necessary. Similarly, aspects of USB or HDMI interface processing can be implemented within separate interface ICs or within processor 1110 as necessary. The demodulated, error corrected, and demultiplexed stream is provided to various processing elements, including, for example, processor 1110, and encoder/decoder 1130 operating in combination with the memory and storage elements to process the datastream as necessary for presentation on an output device.

Various elements of system 1100 can be provided within an integrated housing. Within the integrated housing, the various elements can be interconnected and transmit data therebetween using suitable connection arrangement 1115, for example, an internal bus as known in the art, including the I2C bus, wiring, and printed circuit boards.

The system 1100 includes communication interface 1150 that enables communication with other devices via communication channel 1190. The communication interface 1150 can include, but is not limited to, a transceiver configured to transmit and to receive data over communication channel 1190. The communication interface 1150 can include, but is not limited to, a modem or network card and the communication channel 1190 can be implemented, for example, within a wired and/or a wireless medium.

Data is streamed to the system 1100, in various embodiments, using a Wi-Fi network such as IEEE 802.11. The Wi-Fi signal of these embodiments is received over the communications channel 1190 and the communications interface 1150 which are adapted for Wi-Fi communications. The communications channel 1190 of these embodiments is typically connected to an access point or router that provides access to outside networks including the Internet for allowing streaming applications and other over-the-top communications. Other embodiments provide streamed data to the system 1100 using a set-top box that delivers the data over the HDMI connection of the input block 1105. Still other embodiments provide streamed data to the system 1100 using the RF connection of the input block 1105.

The system 1100 can provide an output signal to various output devices, including a display 1165, speakers 1175, and other peripheral devices 1185. The other peripheral devices 1185 include, in various examples of embodiments, one or more of a stand-alone DVR, a disk player, a stereo system, a lighting system, and other devices that provide a function based on the output of the system 1100. In various embodiments, control signals are communicated between the system 1100 and the display 1165, speakers 1175, or other peripheral devices 1185 using signaling such as AV.Link, CEC, or other communications protocols that enable device-to-device control with or without user intervention. The output devices can be communicatively coupled to system 1100 via dedicated connections through respective interfaces 1160, 1170, and 1180. Alternatively, the output devices can be connected to system 1100 using the communications channel 1190 via the communications interface 1150. The display 1165 and speakers 1175 can be integrated in a single unit with the other components of system 1100 in an electronic device, for example, a television. In various embodiments, the display interface 1160 includes a display driver, for example, a timing controller (T Con) chip.

The display 1165 and speaker 1175 can alternatively be separate from one or more of the other components, for example, if the RF portion of input 1105 is part of a separate set-top box. In various embodiments in which the display 1165 and speakers 1175 are external components, the output signal can be provided via dedicated output connections, including, for example, HDMI ports, USB ports, or COMP outputs.

The embodiments can be carried out by computer software implemented by the processor 1110 or by hardware, or by a combination of hardware and software. As a non-limiting example, the embodiments can be implemented by one or more integrated circuits. The memory 1120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1110 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and is differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate is distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the is phrase “in one embodiment” or “in an embodiment” or “in one implementation” or “in an implementation”, as well any other variations, appearing in various places throughout this document are not necessarily all referring to the same embodiment.

Additionally, this document may refer to “determining” various pieces of information. Determining the information can include one or more of, for example, estimating the information, calculating the information, predicting the information, or retrieving the information from memory.

Further, this document may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this document may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination. Further, embodiments can include one or more of the above exemplary features, devices, or aspects, alone or in any combination, across various claim categories and types.

Various other generalized, as well as particularized, aspects, embodiments and claims are also supported and contemplated throughout this disclosure. For example, various methods and other aspects described in this application can be used to modify modules, for example, motion compensation and estimation modules (170, 175; and 275), of a video encoder 100 and decoder 200 as shown respectively in FIG. 1 and FIG. 2. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

1-15. (canceled)

16. A method for decoding a block of a video using affine mode motion coding, comprising:
obtaining a plurality of control point motion vectors for the block;
determining motion vector differences between control point motion vectors and their respective predictors; and
decoding the video based on the plurality of motion vector differences,
wherein a quantization of at least one of the plurality of motion vector differences is determined based on a block size of the block.

17. The method of claim 16, wherein the block size of the block is a width of the block.

18. The method of claim 17, wherein, in the condition that the width of the block is greater than a threshold, the at least one motion vector difference is determined based on a scaling by a factor equal to the integer division of the threshold divided by the width of the block.

19. The method of claim 17, wherein the quantization uses only power of 2 quantizer.

20. The method of claim 19, wherein the quantization of at least one of the plurality of motion vector differences further comprises selecting a quantizer in a table of quantizers based on the width of the block.

21. The method of claim 20, wherein the pixel accuracy decreases with increasing block size larger than a threshold size.

22. The method of claim 17, wherein at least another additional one of the plurality of motion vector differences is determined independent of the block size.

23. The method of claim 17, wherein the affine mode motion coding is using affine advanced motion vector prediction (AMVP) mode.

24. A method for decoding a block of a video using affine mode motion coding, comprising:
obtaining a plurality of control point motion vectors for the block;
determining motion vector differences between control point motion vectors and their respective predictors; and
decoding the video based on the plurality of motion vector differences,
wherein a quantization of at least one of the plurality of motion vector differences is determined based on a block size of the block.

25. The method of claim 24, wherein the block size of the block is a width of the block.

26. The method of claim 25, wherein, in the condition that the width of the block is greater than a threshold, the at least one motion vector difference is determined based on a scaling by a factor equal to the integer division of the threshold divided by the width of the block.

27. The method of claim 25, wherein the quantization uses only power of 2 quantizer.

28. The method of claim 27, wherein the quantization of at least one of the plurality of motion vector differences further comprises selecting a quantizer in a table of quantizers based on the width of the block.

29. The method of claim 28, wherein the pixel accuracy decreases with increasing block size larger than a threshold size.

30. The method of claim 25, wherein at least another additional one of the plurality of motion vector differences is determined independent of the block size.

31. The method of claim 25, wherein the affine mode motion coding is using affine advanced motion vector prediction (AMVP) mode.

32. An apparatus for decoding a block of a video using affine mode motion coding, comprising one or more processors, wherein the one or more processors are configured to:
obtain a plurality of control point motion vectors for the block;
determine motion vector differences between control point motion vectors and their respective predictors; and
decode the video based on the plurality of motion vector differences,
wherein a quantization of at least one of the plurality of motion vector differences is determined based on a block size of the block.

33. An apparatus for encoding a block of a video using affine mode motion coding, comprising one or more processors, wherein the one or more processors are configured to:
obtain a plurality of control point motion vectors for the block;
determine motion vector differences between control point motion vectors and their respective predictors; and
encode the video based on the plurality of motion vector differences,
wherein a quantization of at least one of the plurality of motion vector differences is determined based on a block size of the block.

34. A non-transitory storage medium having stored therein instructions for causing a processor to decode a block of a video using affine mode motion coding, comprising:
obtaining a plurality of control point motion vectors for the block;
determining motion vector differences between control point motion vectors and their respective predictors; and
decoding the video based on the plurality of motion vector differences,
wherein a quantization of at least one of the plurality of motion vector differences is determined based on a block size of the block.
